(19) United States
(12) Patent Application Publication
(10) Pub. No.: US 2003/0215011 A1
(43) Pub. Date: Nov. 20, 2003

(54) Method and apparatus for transcoding compressed video bitstreams

(75) Inventors: Limin Wang, San Diego, CA (US); Krit Panusopone, San Diego, CA (US)

Correspondence Address: LAW OFFICE OF BARRY R LIPSITZ, 755 MAIN STREET, MONROE, CT, 06468, US

(73) Assignee: General Instrument Corporation, Horsham, PA (US)

(21) Appl. No.: 10/150,269

(22) Filed: May 17, 2002

(51) Int. Cl. H04N 7/12

(52) U.S. Cl. 375/240.03; 375/240.16; 375/240.2; 375/240.12; 375/240.27

(57) ABSTRACT

A technique for transcoding an input compressed video bitstream to an output compressed video bitstream at a different bit rate, includes: receiving an input compressed video bitstream at a first bit rate; specifying a new target bit rate for an output compressed video bitstream; partially decoding the input bitstream to produce dequantized data; requantizing the dequantized data using a different quantization level (QP) to produce requantized data; and re-encoding the requantized data to produce the output compressed video bitstream. An appropriate initial quantization level (QP) is determined for requantizing, the bit rate of the output compressed video bitstream is monitored; and the quantization level is adjusted to make the bit rate of the output compressed video bitstream closely match the target bit rate. Invariant header data is copied directly to the output compressed video bitstream. Requantization errors are determined by dequantizing the requantized data and subtracting from the dequantized data, the quantization errors are IDCT processed to produce an equivalent error image, motion compensation is applied to the error image according to motion compensation parameters from the input compressed video bitstream, the motion compensated error image is DCT processed, and the DCT-processed error image is applied to the dequantized data as motion compensated corrections for errors due to requantization.

### TECHNICAL FIELD

The present invention relates to video compression techniques, and more particularly to encoding, decoding and transcoding techniques for compressed video bitstreams.

### BACKGROUND ART

Video compression is a technique for encoding a video “stream” or “bitstream” into a different encoded form (usually a more compact form) than its original representation. A video “stream” is an electronic representation of a moving picture image.

In recent years, with the proliferation of low-cost personal computers, dramatic increases in the amount of disk space and memory available to the average computer user, widespread availability of access to the Internet and ever-increasing communications bandwidth, the use of streaming video over the Internet has become commonplace. One of the more significant and best known video compression standards for encoding streaming video is the MPEG-4 standard, provided by the Moving Picture Experts Group (MPEG), a working group of the ISO/IEC (International Organization for Standardization/International Engineering Consortium) in charge of the development of international standards for compression, decompression, processing, and coded representation of moving pictures, audio and their combination. The ISO has offices at 1 rue de Varembé, Case postale 56, CH-1211 Geneva 20, Switzerland. The IEC has offices at 549 West Randolph Street, Suite 600, Chicago, Ill. 60661-2208 USA. The MPEG-4 compression standard, officially designated as ISO/IEC 14496 (in 6 parts), is widely known and employed by those involved in motion video applications.

Despite the rapid growth in Internet connection bandwidth and the proliferation of high-performance personal computers, considerable disparity exists between individual users' Internet connection speed and computing power. This disparity requires that Internet content providers supply streaming video and other forms of multimedia content into a diverse set of end-user environments. For example, a news content provider may wish to supply video news clips to end users, but must cater to the demands of a diverse set of users whose connections to the Internet range from a 33.6 Kbps modem at the low end to a DSL, cable modem, or higher-speed broadband connection at the high end. End-users' available computing power is similarly diverse. Further complicating matters is network congestion, which serves to limit the rate at which streaming data (e.g., video) can be delivered when Internet traffic is high. This means that the news content provider must make streaming video available at a wide range of bit-rates, tailored to suit the end users' wide range of connection/computing environments and to varying network conditions.

One particularly effective means of providing the same video program material at a variety of different bit rates is video transcoding. Video transcoding is a process by which a pre-compressed bit stream is transformed into a new compressed bit stream with different bit rate, frame size, video coding standard, etc. Video transcoding is particularly useful in any application in which a compressed video bit stream must be delivered at different bit rates, resolutions or formats depending on factors such as network congestion, decoder capability or requests from end users.

Typically, a compressed video transcoder decodes a compressed video bit stream and subsequently re-encodes the decoded bit stream, usually at a lower bit rate. Although non-transcoder techniques can provide similar capability, there are significant cost and storage disadvantages to those techniques. For example, video content for multiple bit rates, formats and resolutions could each be separately encoded and stored on a video server. However, this approach provides only as many discrete selections as were anticipated and pre-encoded, and requires large amounts of disk storage space. Alternatively, a video sequence can be encoded into a compressed “scalable” form. However, this technique requires substantial video encoding resources (hardware and/or software) to provide a limited number of selections.

Transcoding techniques provide significant advantages over these and other non-transcoder techniques due to their extreme flexibility in providing a broad spectrum of bit rate, resolution and format selections. The number of different selections that can be accommodated simultaneously depends only upon the number of independent video streams that can be independently transcoded.

In order to accommodate large numbers of different selections simultaneously, a large number of transcoders must be provided. Despite the cost and flexibility advantages of transcoders in such applications, large numbers of transcoders can still be quite costly, due largely to the significant hardware and software resources that must be dedicated to conventional video transcoding techniques.

As is evident from the foregoing discussing, there is a need for a video transcoder that minimizes implementation cost and complexity.

### SUMMARY OF THE INVENTION

According to the invention, a method for transcoding an input compressed video bitstream to an output compressed video bitstream at a different bit rate comprises receiving an input compressed video bitstream at a first bit rate. A new target bit rate is specified for an output compressed video bitstream. The input bitstream is partially decoded to produce dequantized data. The dequantized data is requantized using a different quantization level (QP) to produce requantized data, and the requantized data is re-encoded to produce the output compressed video bitstream.

According to an aspect of the invention, the method further comprises determining an appropriate initial quantization level (QP) for requantizing. The bit rate of the output compressed video bitstream is monitored, and the quantization level is adjusted to make the bit rate of the output compressed video bitstream closely match the target bit rate.

According to another aspect of the invention, the method further comprises copying invariant header data directly to the output compressed video bitstream.

According to another aspect of the invention, the method further comprises determining requantization errors by dequantizing the requantized data and subtracting from the dequantized data. The quantization errors are processed using an inverse discrete cosine transform (IDCT) to produce an equivalent error image. Motion compensation is applied to the error image according to motion compensation parameters from the input compressed video bitstream. The motion compensated error image is DCT processed and the DCT-processed error image is applied to the dequantized data as motion compensated corrections for errors due to requantization.

According to another aspect of the invention, requantization errors are represented as 8 bit signed numbers and offset by an amount equal to one-half of their span (i.e., +128) prior to their storage in an 8 bit unsigned storage buffer. After retrieval, the offset is subtracted, thereby restoring the original signed requantization error values.

According to another aspect of the invention, an all-zero CBP (coded block pattern) is presented to the transcoder in place of macroblocks coded as “skipped”. Additionally, for predictive coding modes that use motion compensation, all-zero motion vectors (MVs) are presented to the transcoder for “skipped” macroblocks.

According to another aspect of the invention, if transcoding results in an all-zero coded block pattern (CBP), a coding mode of “skipped” is selected. This approach is used primarily for encoding modes that do not make use of compensation data (e.g., motion compensation). For predictive modes that make use of motion compensation data, the “skipped” mode is selected when the transcoded CBP is all-zero and the motion vectors are all-zero.

Apparatus implementing the methods is also described.

### GLOSSARY

Unless otherwise noted, or as may be evident from the context of their usage, any terms, abbreviations, acronyms or scientific symbols and notations used herein are to be given their ordinary meaning in the technical discipline to which the invention most nearly pertains. The following glossary of terms is intended to lend clarity and consistency to the various descriptions contained herein, as well as in prior art documents:

AC coefficient: Any DCT coefficient for which the frequency in one or both dimensions is non-zero.

MPEG: Moving Picture Experts Group

MPEG-4: A variant of a MPEG moving picture encoding standard aimed at multimedia applications and streaming video, targeting a wide range of bit rates. Officially designated as ISO/IEC 14496, in 6 parts.

B-VOP;

bidirectionally predictive-coded VOP: A VOP that is coded using motion compensated prediction from past and/or future reference VOPs

backward compatibility: A newer coding standard is backward compatible with an older coding standard if decoders designed to operate with the older coding standard are able to continue to operate by decoding all or part of a bitstream produced according to the newer coding standard.

backward motion vector: A motion vector that is used for motion compensation from a reference VOP at a later time in display order.

backward prediction: Prediction from the future reference VOP

base layer: An independently decodable layer of a scalable hierarchy

binary alpha block: A block of size 16×16 pels, co-located with macroblock, representing shape information of the binary alpha map; it is also referred to as a bab.

binary alpha map: A 2D binary mask used to represent the shape of a video object such that the pixels that are opaque are considered as part of the object where as pixels that are transparent are not considered to be part of the object.

bitstream; stream: An ordered series of bits that forms the coded representation of the data.

bitrate: The rate at which the coded bitstream is delivered from the storage medium or network to the input of a decoder.

block: An 8-row by 8-column matrix of samples (pixels), or 64 DCT coefficients (source, quantized or dequantized).

byte aligned: A bit in a coded bitstream is byte-aligned if its position is a multiple of 8-bits from the first bit in the stream.

byte: Sequence of 8-bits.

context based arithmetic encoding: The method used for coding of binary shape; it is also referred to as cae.

channel: A digital medium or a network that stores or transports a bitstream constructed according to the MPEG-4 (ISO/IEC 14496) specification.

chrominance format: Defines the number of chrominance blocks in a macroblock.

chrominance component: A matrix, block or single sample representing one of the two color difference signals related to the primary colors in the manner defined in the bitstream. The symbols used for the chrominance signals are Cr and Cb.

CBP: Coded Block Pattern

CBPY: This variable length code represents a pattern of non-transparent luminance blocks with at least one non intra DC transform coefficient, in a macroblock.

coded B-VOP: A B-VOP that is coded.

coded VOP: A coded VOP is a coded I-VOP, a coded P-VOP or a coded B-VOP.

coded I-VOP: An I-VOP that is coded.

coded P-VOP: A P-VOP that is coded.

coded video bitstream: A coded representation of a series of one or more VOPs as defined in the MPEG-4 (ISO/IEC 14496) specification.

coded order: The order in which the VOPs are transmitted and decoded. This order is not necessarily the same as the display order.

coded representation: A data element as represented in its encoded form.

coding parameters: The set of user-definable parameters that characterize a coded video bitstream. Bitstreams are characterized by coding parameters. Decoders are characterized by the bitstreams that they are capable of decoding.

component: A matrix, block or single sample from one of the three matrices (luminance and two chrominance) that make up a picture.

composition process: The (non-normative) process by which reconstructed VOPs are composed into a scene and displayed.

compression: Reduction in the number of bits used to represent an item of data.

constant bitrate

coded video: A coded video bitstream with a constant bitrate.

constant bitrate; CBR: Operation where the bitrate is constant from start to finish of the coded bitstream.

conversion ratio: The size conversion ratio for the purpose of rate control of shape.

data element: An item of data as represented before encoding and after decoding.

DC coefficient: The DCT coefficient for which the frequency is zero in both dimensions.

DCT coefficient: The amplitude of a specific cosine basis function. decoder input buffer: The first-in first-out (FIFO) buffer specified in the video buffering verifier.

decoder: An embodiment of a decoding process.

decoding (process): The process defined in this specification that reads an input coded bitstream and produces decoded VOPs or audio samples.

dequantization: The process of resealing the quantized DCT coefficients after their representation in the bitstream has been decoded and before they are presented to the inverse DCT.

digital storage media;

DSM: A digital storage or transmission device or system.

discrete cosine transform;

DCT: Either the forward discrete cosine transform or the inverse discrete cosine transform. The DCT is an invertible, discrete orthogonal transformation.

display order: The order in which the decoded pictures are displayed. Normally this is the same order in which they were presented at the input of the encoder.

DQUANT: A 2-bit code which specifies the change in the quantizer, quant, for I-, P-, and S(GMC)-VOPs.

editing: The process by which one or more coded bitstreams are manipulated to produce a new coded bitstream. Conforming edited bitstreams must meet the requirements defined in the MPEG-4 (ISO/IEC 14496) specification.

encoder: An embodiment of an encoding process.

encoding (process): A process, not specified in this specification, that reads a stream of input pictures or audio samples and produces a valid coded bitstream as defined in the MPEG-4 (ISO/IEC 14496) specification.

enhancement layer: A relative reference to a layer (above the base layer) in a scalable hierarchy. For all forms of scalability, its decoding process can be described by reference to the lower layer decoding process and the appropriate additional decoding process for the enhancement layer itself.

face animation parameter units;

FAPU: Special normalized units (e.g. translational, angular, logical) defined to allow interpretation of FAPs with any facial model in a consistent way to produce reasonable results in expressions and speech pronunciation.

face animation parameters;

FAP: Coded streaming animation parameters that manipulate the displacements and angles of face features, and that govern the blending of visemes and face expressions during speech.

face animation table;

FAT: A downloadable function mapping from incoming FAPs to feature control points in the face mesh that provides piecewise linear weightings of the FAPs for controlling face movements.

face calibration mesh: Definition of a 3D mesh for calibration of the shape and structure of a baseline face model.

face definition parameters;

FDP: Downloadable data to customize a baseline face model in the decoder to a particular face, or to download a face model along with the information about how to animate it. The FDPs are normally transmitted once per session, followed by a stream of compressed FAPs. FDPs may include feature points for calibrating a baseline face, face texture and coordinates to map it onto the face,animation tables, etc.

face feature control point: A normative vertex point in a set of such points that define the critical locations within face features for control by FAPs and that allow for calibration of the shape of the baseline face.

face interpolation transform;

FIT: A downloadable node type defined in ISO/IEC 14496-1 for optional mapping of incoming FAPs to FAPs before their application to feature points, through weighted rational polynomial functions, for complex cross-coupling of standard FAPs to link their effects into custom or proprietary face models.

face model mesh: A 2D or 3D contiguous geometric mesh defined by vertices and planar polygons utilizing the vertex coordinates, suitable for rendering with photometric attributes (e.g. texture, color, normals).

feathering: A tool that tapers the values around edges of binary alpha mask for composition with the background.

flag: A one bit integer variable which may take one of only two values (zero and one).

forbidden: The term “forbidden” when used in the clauses defining the coded bitstream indicates that the value shall never be used. This is usually to avoid emulation of start codes.

forced updating: The process by which macroblocks are intra-coded from time-to-time to ensure that mismatch errors between the inverse DCT processes in encoders and decoders cannot build up excessively.

forward compatibility: A newer coding standard is forward compatible with an older coding standard if decoders designed to operate with the newer coding standard are able to decode bitstreams of the older coding standard.

forward motion vector: A motion vector that is used for motion compensation from a reference frame VOP at an earlier time in display order.

forward prediction: Prediction from the past reference VOP.

frame: A frame contains lines of spatial information of a video signal. For progressive video, these lines contain samples starting from one time instant and continuing through successive lines to the bottom of the frame.

frame period: The reciprocal of the frame rate.

frame rate: The rate at which frames are be output from the composition process.

future reference VOP: A future reference VOP is a reference VOP that occurs at a later time than the current VOP in display order.

GMC Global Motion Compensation

GOV: Group Of VOP

hybrid scalability: Hybrid scalability is the combination of two (or more) types of scalability.

interlace: The property of conventional television frames where alternating lines of the frame represent different instances in time. In an interlaced frame, one of the field is meant to be displayed first. This field is called the first field. The first field can be the top field or the bottom field of the frame.

I-VOP; intra-coded VOP: A VOP coded using information only from itself.

intra coding: Coding of a macroblock or VOP that uses information only from that macroblock or VOP.

intra shape coding: Shape coding that does not use any temporal prediction.

inter shape coding Shape coding that uses temporal prediction.

level: A defined set of constraints on the values which may be taken by the parameters of the MPEG-4 (ISO/IEC 14496-2) specification within a particular profile. A profile may contain one or more levels. In a different context, level is the absolute value of a non-zero coefficient (see “run”).

layer: In a scalable hierarchy denotes one out of the ordered set of bitstreams and (the result of) its associated decoding process.

layered bitstream: A single bitstream associated to a specific layer (always used in conjunction with layer qualifiers, e.g. “enhancement layer bitstream”)

lower layer: A relative reference to the layer immediately below a given enhancement layer (implicitly including decoding of all layers below this enhancement layer)

luminance component: A matrix, block or single sample representing a monochrome representation of the signal and related to the primary colors in the manner defined in the bitstream. The symbol used for luminance is Y.

Mbit: 1,000,000 bits

MB; macroblock: The four 8×8 blocks of luminance data and the two (for 4:2:0 chrominance format) corresponding 8×8 blocks of chrominance data coming from a 16×16 section of the luminance component of the picture. Macroblock is sometimes used to refer to the sample data and sometimes to the coded representation of the sample values and other data elements defined in the macroblock header of the syntax defined in the MPEG-4 (ISO/IEC 14496-2) specification. The usage is clear from the context.

MCBPC Macroblock Pattern Coding. This is a variable length code that is used to derive the macroblock type and the coded block pattern for chrominance. It is always included for coded macroblocks.

mesh: A 2D triangular mesh refers to a planar graph which tessellates a video object plane into triangular patches. The vertices of the triangular mesh elements are referred to as node points. The straight-line segments between node points are referred to as edges. Two triangles are adjacent if they share a common edge.

mesh geometry: The spatial locations of the node points and the triangular structure of a mesh.

mesh motion: The temporal displacements of the node points of a mesh from one time instance to the next.

MC;

motion compensation: The use of motion vectors to improve the efficiency of the prediction of sample values. The prediction uses motion vectors to provide offsets into the past and/or future reference VOPs containing previously decoded sample values that are used to form the prediction error.

motion estimation: The process of estimating motion vectors during the encoding process.

motion vector: A two-dimensional vector used for motion compensation that provides an offset from the coordinate position in the current picture or field to the coordinates in a reference VOP.

motion vector for shape: A motion vector used for motion compensation of shape.

non-intra coding: Coding of a macroblock or a VOP that uses information both from itself and from macroblocks and VOPs occurring at other times.

opaque macroblock: A macroblock with shape mask of all 255's.

P-VOP;

predictive-coded VOP: A picture that is coded using motion compensated prediction from the past VOP.

parameter: A variable within the syntax of this specification which may take one of a range of values. A variable which can take one of only two values is called a flag.

past reference picture: A past reference VOP is a reference VOP that occurs at an earlier time than the current VOP in composition order.

picture: Source, coded or reconstructed image data. A source or reconstructed picture consists of three rectangular matrices of 8-bit numbers representing the luminance and two chrominance signals. A “coded VOP” was defined earlier. For progressive video, a picture is identical to a frame.

prediction: The use of a predictor to provide an estimate of the sample value or data element currently being decoded.

prediction error: The difference between the actual value of a sample or data element and its predictor.

predictor: A linear combination of previously decoded sample values or data elements.

profile: A defined subset of the syntax of this specification.

progressive: The property of film frames where all the samples of the frame represent the same instances in time.

quantization matrix: A set of sixty-four 8-bit values used by the dequantizer.

quantized DCT coefficients:DCT coefficients before dequantization. A variable length coded representation of quantized DCT coefficients is transmitted as part of the coded video bitstream.

quantizer scale: A scale factor coded in the bitstream and used by the decoding process to scale the dequantization.

QP Quantization parameters

random access: The process of beginning to read and decode the coded bitstream at an arbitrary point.

reconstructed VOP: A reconstructed VOP consists of three matrices of 8-bit numbers representing the luminance and two chrominance signals. It is obtained by decoding a coded VOP

reference VOP: A reference frame is a reconstructed VOP that was coded in the form of a coded I-VOP or a coded P-VOP. Reference VOPs are used for forward and backward prediction when P-VOPs and B-VOPs are decoded.

reordering delay: A delay in the decoding process that is caused by VOP reordering.

reserved: The term “reserved” when used in the clauses defining the coded bitstream indicates that the value may be used in the future for ISO/IEC defined extensions.

scalable hierarchy: Coded video data consisting of an ordered set of more than one video bitstream.

scalability: Scalability is the ability of a decoder to decode an ordered set of bitstreams to produce a reconstructed sequence. Moreover, useful video is output when subsets are decoded. The minimum subset that can thus be decoded is the first bitstream in the set which is called the base layer. Each of the other bitstreams in the set is called an enhancement layer. When addressing a specific enhancement layer, “lower layer” refers to the bitstream that precedes the enhancement layer.

side information: Information in the bitstream necessary for controlling the decoder.

run: The number of zero coefficients preceding a non-zero coefficient, in the scan order. The absolute value of the non-zero coefficient is called “level”.

saturation: Limiting a value that exceeds a defined range by setting its value to the maximum or minimum of the range as appropriate.

source; input: Term used to describe the video material or some of its attributes before encoding.

spatial prediction: prediction derived from a decoded frame of the lower layer decoder used in spatial scalability

spatial scalability: A type of scalability where an enhancement layer also uses predictions from sample data derived from a lower layer without using motion vectors. The layers can have different VOP sizes or VOP rates.

static sprite: The luminance, chrominance and binary alpha plane for an object which does not vary in time.

sprite-VOP; S-VOP: A picture that is coded using information obtained by warping whole or part of a static sprite.

start codes: 32-bit codes embedded in that coded bitstream that are unique. They are used for several purposes including identifying some of the structures in the coding syntax.

stuffing (bits);

stuffing (bytes): Code-words that may be inserted into the coded bitstream that are discarded in the decoding process. Their purpose is to increase the bitrate of the stream which would otherwise be lower than the desired bitrate.

temporal prediction: prediction derived from reference VOPs other than those defined as spatial prediction

temporal scalability: A type of scalability where an enhancement layer also uses predictions from sample data derived from a lower layer using motion vectors. The layers have identical frame size, and but can have different VOP rates.

top layer: the topmost layer (with the highest layer id) of a scalable hierarchy.

transparent macroblock: A macroblock with shape mask of all zeros.

variable bitrate; VBR: Operation where the bitrate varies with time during the decoding of a coded bitstream.

variable length coding;

VLC: A reversible procedure for coding that assigns shorter code-words to frequent events and longer code-words to less frequent events.

video buffering verifier;

VBV: A hypothetical decoder that is conceptually connected to the output of the encoder. Its purpose is to provide a constraint on the variability of the data rate that an encoder or editing process may produce.

Video Object;

VO: Composition of all VOP's within a frame.

Video Object Layer;

VOL: Temporal order of a VOP.

Video Object Plane;

VOP: Region with arbitrary shape within a frame belonging together

VOP reordering: The process of reordering the reconstructed VOPs when the coded order is different from the composition order for display. VOP reordering occurs when B-VOPs are present in a bitstream. There is no VOP reordering when decoding low delay bitstreams.

video session: The highest syntactic structure of coded video bitstreams. It contains a series of one or more coded video objects.

viseme: the physical (visual) configuration of the mouth, tongue and jaw that is visually correlated with the speech sound corresponding to a phoneme.

warping: Processing applied to extract a sprite VOP from a static sprite. It consists of a global spatial transformation driven by a few motion parameters (0,2,4,8), to recover luminance, chrominance and shape information.

zigzag scanning order: A specific sequential ordering of the DCT coefficients from (approximately) the lowest spatial frequency to the highest.

### BRIEF DESCRIPTION OF THE DRAWINGS

FIG. 1 is a block diagram of a complete video transcoder, in accordance with the invention;

FIG. 2A is a structure diagram of a typical MPEG-4 video stream, in accordance with the invention;

FIG. 2B is a structure diagram of a typical MPEG-4 Macroblock (MB), in accordance with the invention;

FIG. 3 is a block diagram of a technique for extracting data from a coded MB, in accordance with the invention;

FIGS. 4A-4G are block diagrams of a transcode portion of a complete video transcoder as applied to various different encoding formats, in accordance with the invention;

FIG. 5 is a flowchart of a technique for determining a re-encoding mode for I-VOPs, in accordance with the invention;

FIG. 6 is a flowchart of a technique for determining a re-encoding mode for P-VOPs, in accordance with the invention;

FIGS. 7a and 7b are a flowchart of a technique for determining a re-encoding mode for S-VOPs, in accordance with the invention;

FIGS. 8a and 8b are a flowchart of a technique for determining a re-encoding mode for B-VOPs, in accordance with the invention;

FIG. 9 is block diagram of a re-encoding portion of a complete video transcoder, in accordance with the invention;

FIG. 10 is a table comparing signal-to-noise ratios for a specific set of video sources between direct MPEG-4 encoding, cascaded coding, and transcoding in accordance with the invention; and

FIG. 11 is a graph comparing signal-to-noise ratio between direct MPEG-4 encoding and transcoding in accordance with the invention.

### DETAILED DESCRIPTION OF THE INVENTION

The present invention relates to video compression techniques, and more particularly to encoding, decoding and transcoding techniques for compressed video bitstreams.

According to the invention, a cost-effective, efficient transcoder is provided by decoding an input stream down to the macroblock level, analyzing header information, dequantizing and partially decoding the macroblocks, adjusting the quantization parameters to match desired output stream characteristics, then requantizing and re-encoding the macroblocks, and copying unchanged or invariant portions of the header information from the input stream to the output stream.

Video Transcoder

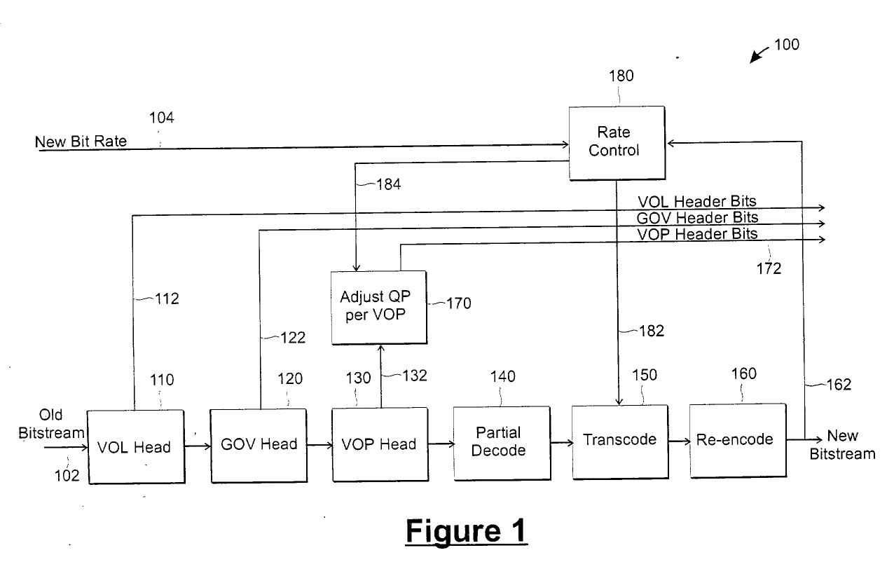

FIG. 1 is a block diagram of a complete video transcoder 100, in accordance with the invention. An input bitstream (“Old Bitstream”) 102 to be transcoded enters the transcoder 100 at a VOL (Video Object Layer) header processing block 110 and is processed serially through three header processing blocks (VOL header processing block 110, GOV header processing block 120 and VOP header processing block 130), a partial decode block 140, a transcode block 150 and a re-encode block 160).

The VOL header processing block 110 decodes and extracts VOL header bits 112 from the input bitstream 102. Next, the GOV (Group Of VOP) Header processing block 120, decodes and extracts GOV header bits 122. Next, the VOP (Video Object Plane) header processing block 130 decodes and extracts input VOP header bits 132. The input VOP header bits 132 contain information, including quantization parameter information, about how associated macroblocks within the bitstream 102 were originally compressed and encoded.

After the VOL, GOV and VOP header bits (112, 122 and 132, respectively) have been extracted, the remainder of the bitstream (composed primarily of macroblocks, discussed hereinbelow) is partially decoded in a partial decode block 140. The partial decode block 140 consists of separating macroblock data from macroblock header information and dequantizing it as required (according to encoding information stored in the header bits) into a usable form.

A Rate Control block 180 responds to a desired new bit rate input signal 104 by determining new quantization parameters 182 and 184 by which the input bitstream 102 should be re-compressed. This is accomplished, in part, by monitoring the new bitstream 162 (discussed below) and adjusting quantization parameters 182 and 184 to maintain the new bitstream 162 at the desired bit rate. These newly determined quantization parameters 184 are then merged into the input VOP header bits 132 in an adjustment block 170 to produce output VOP header bits 172. The rate control block 180 also provides quantization parameter information 182 to the transcode block 150 to control re-quantization (compression) of the video data decoded from the input bitstream 102.

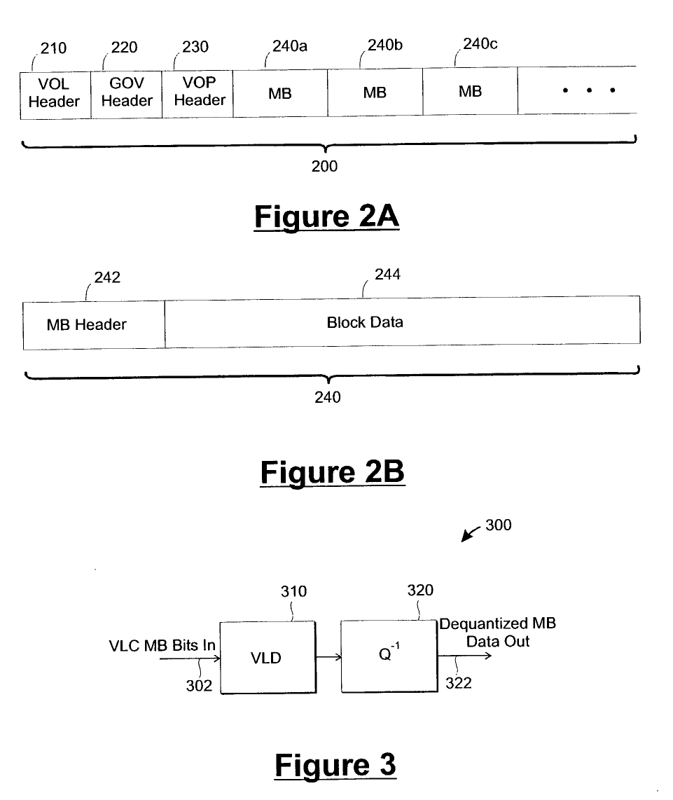

The transcode block 150, operates on dequantized macroblock data from the partial decode block 140 and re-quantizes it according to new quantization parameters 182 from the rate control block 180. The transcode block 150 also processes motion compensation and interpolation data encoded into the macroblocks, keeping track of and compensating for quantization errors (differences between the original bitstream and the re-quantized bitstream due to quantization) and determining an encoding mode for each macroblock in the re-quantized bitstream. A re-encode block 160 then re-encodes the transcoded bitstream according to the encoding mode determined by the transcoder to produce a new bitstream (New Bitstream) 162. The re-encode block also re-inserts the VOL, GOV (if required) and VOP header bits (112, 122 and 132, respectively) into the new bitstream 162 at the appropriate place. (Header information is described in greater detail hereinbelow with respect to FIG. 2A.)

The input bitstream 102 can be either VBR (variable bit rate) or CBR (constant bit rate) encoded. Similarly, the output bitstream can be either VBR or CBR encoded.

MPEG-4 Bitstream Structure

FIG. 2A is a diagram of the structure of an MPEG-4 bitstream 200, showing its layered structure as defined in the MPEG-4 specification. A VOL header 210 includes the following information:

Object Layer ID

VOP time increment resolution

fixed VOP rate

object size

interlace/no-interlace indicator

sprite/GMC

quantization type

quantization matrix, if any

The information contained in the VOL header 210 affects how all of the information following it should be interpreted and processed.

Following the VOL header is a GOV header 220, which includes the following information:

time code,

close/open

broken link

The GOV (Group Of VOP) header 220 controls the interpretation and processing of one or more VOPs that follow it.

Each VOP comprises a VOP header 230 and one or more macroblocks (MBs) (240a,b,c . . . ). The VOP header 230 includes the following information:

VOP coding type (P,B,S or I)

VOP time increment

coded/direct (not coded)

rounding type

initial quantization parameters (QP)

fcode for motion vectors (MV)

The VOP header 230 affects the decoding and interpretation of MBs (240) that follow it.

FIG. 2B shows the general format of a macroblock (MB) 240. A macroblock or MB 240 consists of an MB Header 242 and block data 244. The format of and information encoded into an MB header 242 depends upon the VOP header 230 that defines it. Generally speaking, the MB header 242 includes the following information:

code mode (intra, inter, etc)

coded or direct (not coded)

coded block pattern (CBP)

AC prediction flag (AC_pred)

Quantization Parameters (QP)

interlace/no-interlace

Motion Vectors (MVs)

The block data 244 associated with each MB header contains variable-length coded (VLC) DCT coefficients for six (6) eight-by-eight (8×8) pixel blocks represented by the MB.

Header Processing

Referring again to FIG. 1, upon being presented with a bitstream, the VOL Header processing block 110 examines the input bitstream 102 for an identifiable VOL Header. Upon detecting a VOL Header, processing of the input bitstream 102 begins by identifying and decoding the headers associated with the various encoded layers (VOL, GOV, VOP, etc.) of the input bitstream. VOL, GOV, and VOP headers are processed as follows:

1. VOL Header Processing:

The VOL Header processing block 110 detects and identifies a VOL Header (as defined by the MPEG-4 specification) in the input bitstream 102 and then decodes the information stored in the VOL Header. This information is then passed on to the GOV Header processing block 120, along with the bitstream, for further analysis and processing. The VOL Header bits 112 are separated out for re-insertion into the output bitstream (“new bitstream”) 162. For rate-reduction transcoding, there is no need to change any information in the VOL Header between the input bitstream 102 and the output bitstream 162. Accordingly, the VOL Header bits 112 are simply copied into the appropriate location in the output bitstream 162.

2. GOV Header Processing:

Based upon information passed on by the VOL Header processing block 110, the GOV header processing block 120 searches for a GOV Header (as defined by the MPEG-4 specification) in the input bitstream 102. Since VOPs (and VOP headers) may or may not be encoded under a GOV Header, a VOP header can occur independently of a GOV Header. If a GOV Header occurs in the input bitstream 102, it is identified and decoded by the GOV Header processing block 120 and the GOV Header bits 122 are separated out for re-insertion into the output bitstream 162. Any decoded GOV header information is passed along with the input bitstream to the VOP Header processing block 130 for further analysis and processing. As with the VOL Header, there is no need to change any information in the GOV Header between the input bitstream 102 and the output bitstream 162, so the GOV Header bits 122 are simply copied into the appropriate location in the output bitstream 162.

3. VOP Header Processing:

The VOP Header processing block 130 identifies and decodes any VOP header (as defined in the MPEG-4 specification) in the input bitstream 102. The detected VOP Header bits 132 are separated out and passed on to a QP adjustment block 170. The decoded VOP Header information is also passed on, along with the input bitstream 102, to the partial decode block 140 for further analysis and processing. The decoded VOP header information is used by the partial decode block 140 and transcode block 150 for MB (macroblock) decoding and processing. Since the MPEG-4 specification limits the change in QP from MB to MB by up to +/−2, it is essential that proper initial QPs are specified for each VOP. These initial QPs form a part of the VOP Header. According to the New Bit Rate 104 presented to the Rate Control block 180, and in the context of the bit rate observed in the output bitstream 162, the Rate Control block 180 determines appropriate quantization parameters (QP) 182 and provides them to the transcode block 180 for MB re-quantization. Appropriate initial quantization parameters 184 are provided to the QP adjustment block 170 for modification of the detected VOP header bits 132 and new VOP Header bits 172 are generated by merging the initial QPs into the detected VOP Header bits 132. The new VOP Header bits 172 are then inserted into the appropriate location in the output bitstream 162.

4. MB Header Processing:

MPEG-4 is a block-based encoding scheme wherein each frame is divided into MBs (macroblocks). Each MB consists of one 16×16 luminance block (i.e., four 8×8 blocks) and two 8×8 chrominance blocks. The MBs in a VOP are encoded one-by-one from left to right and top to bottom. As defined in the MPEG-4 specification, a VOP is represented by a VOP header and many MBs (see FIG. 2A). In the interest of efficiency and simplicity, the MPEG-4 transcoder 100 of the present invention only partially decodes MBs. That is, the MBs are only VLD processed (variable-length decode, or decoding of VLC-coded data) and dequantized.

FIG. 3 is a block diagram of a partial decode block 300 (compare 130, FIG. 1). MB block data consists of VLC-encoded, quantized DCT coefficients. These must be converted to unencoded, de-quantized coefficients for analysis and processing. Variable-length coded (VLC) MB block data bits 302 are VLD processed by a VLD block 310 to expand them into unencoded, quantized DCT coefficients, and then are dequantized in a dequantization block (Q⁻¹) 320 to produce Dequantized MB data 322 in the form of unencoded, dequantized DCT coefficients 322.

The encoding and interpretation of the MB Header (242) and MB Block Data (244) depends upon the type of VOP to which they belong. The MPEG-4 specification defines four types of VOP: I-VOP or “Intra-coded” VOP, P-VOP or “Predictive-coded” VOP, S-VOP or “Sprite” VOP and B-VOP or “Bidirectionally” predictive-coded VOP. The information contained in the MB Header (242) and the format and interpretation of the MB Block Data (244) for each type of VOP is as follows:

MB Layer in I-VOP

As defined by the MPEG-4 Specification, MB Headers in I-VOPs include the following coding parameters:

MCBPC

AC prediction flag (AC_red_flag)

CBPY

DQUANT, and

Interlace_inform

There are only two coding modes for MB Block Data defined for I-VOPs: intra and intra_q.

MCBPC indicates the type of MB and the coded pattern of the two 8×8 chrominance blocks. AC_pred_flag indicates if AC prediction is to be used. CBPY is the coded pattern of the four 8×8 luminance blocks. DQUANT indicates differential quantization. If interlace is set in VOL layer, interlace_inform includes the DCT (discrete cosine transform) type to be used in transforming the DCT coefficients in the MB Block Data.

MB Layer in P-VOP

As defined by the MPEG-4 Specification, MB Headers in P-VOPs may include the following coding parameters:

COD

MCBPC

AC prediction flag (AC_pred_flag)

CBPY

DQUANT

Interlace_inform

MVD

MVD

MVD3 and

MCD4

Motion Vectors (MVs) of a MB are differentially encoded. That is, Motion Vector Difference (MVDs), not MVs, are encoded. MVD=MV−PMV, where PMV is the predicted MV.

There are six coding modes defined for MB Block Data in I-VOPs: not_coded, inter, inter_q, inter_{—}4MV, intra and intra_q.

COD is an indicator of whether the MB is coded or not. MCBPC indicates the type of MB and the coded pattern of the two 8×8 chrominance blocks. AC_pred_flag is only present when MCBPC indicates either intra or intra_q coding, in which case it indicates if AC prediction is to be used. CBPY is the coded pattern of the four 8×8 luminance blocks. DQUANT indicates differential quantization. If interlace is specified in the VOL Header, interlace_inform specifies DCT (discrete cosine transform) type, field prediction, and forward top or bottom prediction. MVD, MVD2, MVD3 and MVD4 are only present when appropriate to the coding specified by MCBPC. Block Data are present only when appropriate to the coding specified by MCBPC and CBPY.

MB Layer in S-VOP

As defined by the MPEG-4 Specification, MB Headers in P-VOPs may include the following coding parameters:

COD

MCBPC

MCSEL

AC_pred_flag

CBPY

DQUANT

Interlace_inform

MVD

MVD2

MVD3 and

MCD4

In addition to the six code modes defined in P-VOP, the MPEG-4 specification defines two additional coding modes for S-VOPs: inter_gmc and inter_gmc_q. MCSEL occurs after MCBPC only when the coding type specified by MCBPC is inter or inter_q. When MCSEL is set, the MB is coded in inter_gmc or inter_gmc_q, and no MVDs (MVD, MVD2, MVD3, MVD4) follow. Inter_gmc is a coding mode where an MB is coded in inter mode with global motion compensation.

MB Layer in B-VOP

As defined by the MPEG-4 Specification, MB Headers in P-VOPs may include the following coding parameters:

MODB

MBTYPE

CBPB

DQUANT

Interlace_inform

MVDf

MVDb, and

MVDB

CBPB is a 3 to 6 bit code representing the coded block pattern for B-VOPs, if indicated by MODB. MODB is a variable length code present only in coded macroblocks of B-VOPs. It indicates whether MBTYPE and/or CBPB information is present for the macroblock.

The MPEG-4 specification defines five coding modes for MBs in B-VOPs: not_coded, direct, interpolate_MC_Q, backward_MC_Q, and forward_MC_Q. If an MB of the most recent I- or P-VOP is skipped, the corresponding MB in the B-VOP is also skipped. Otherwise, the MB is non-skipped. MODB is present for every non-skipped MB in a B-VOP. MODB indicates if MBTYPE and CBPB will follow. MBTYPE indicates motion vector mode (MVDf, MVDb and MVDB present) and quantization (DQUANT).

Transcoding

Referring again to FIG. 1, after VLD decoding and de-quantization in the partial decode block 140, decoded and dequantized MB block data (refer to 322, FIG. 3) is passed to the transcoding engine 150 (along with information determined in previous processing blocks). The transcode block 150 requantizes the dequantized MB block data using new quantization parameters (QP) 182 from the rate control block (described in greater detail hereinbelow), and constructs a re-coded (transcoded) MB, determines an appropriate new coding mode for the new MB. The VOP type and MB encoding (as specified in the MB header), affects the way the transcode block 150 processes decoded and dequantized block data from the partial decode block 140. Each MB type (as defined by VOP type/MB header) has a specific strategy (described in detail hereinbelow) for determining the encoding type for the new MB.

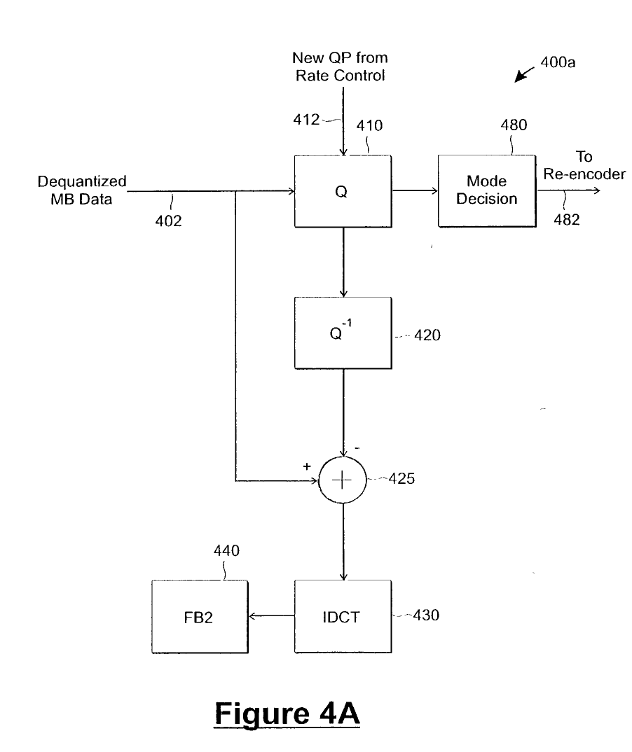

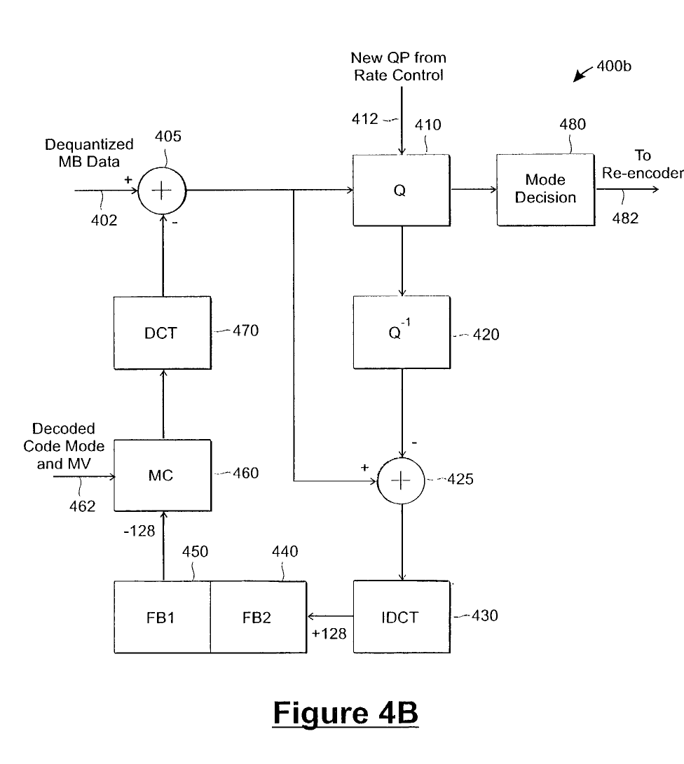

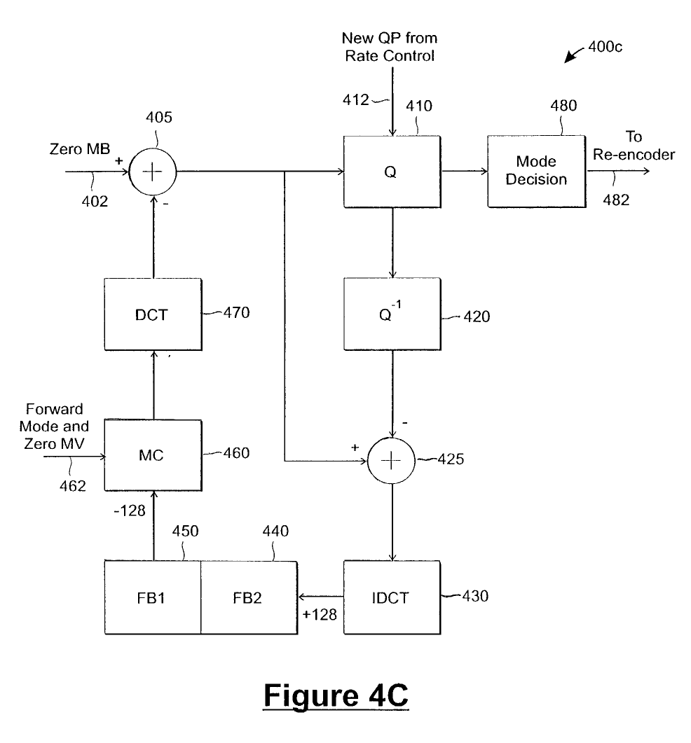

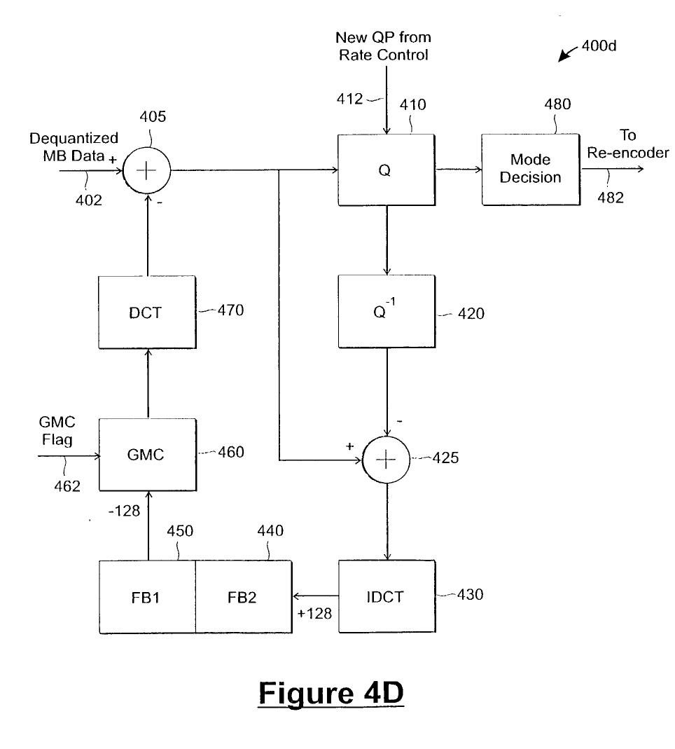

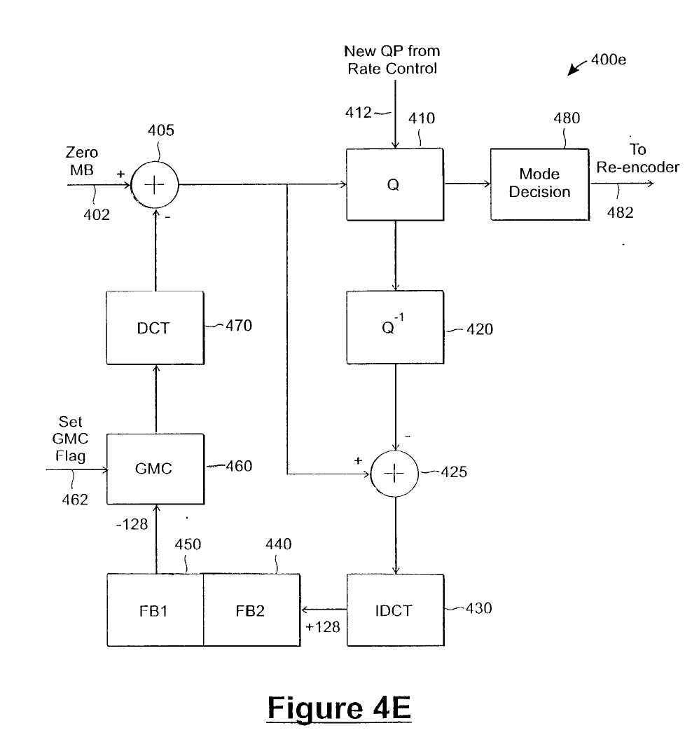

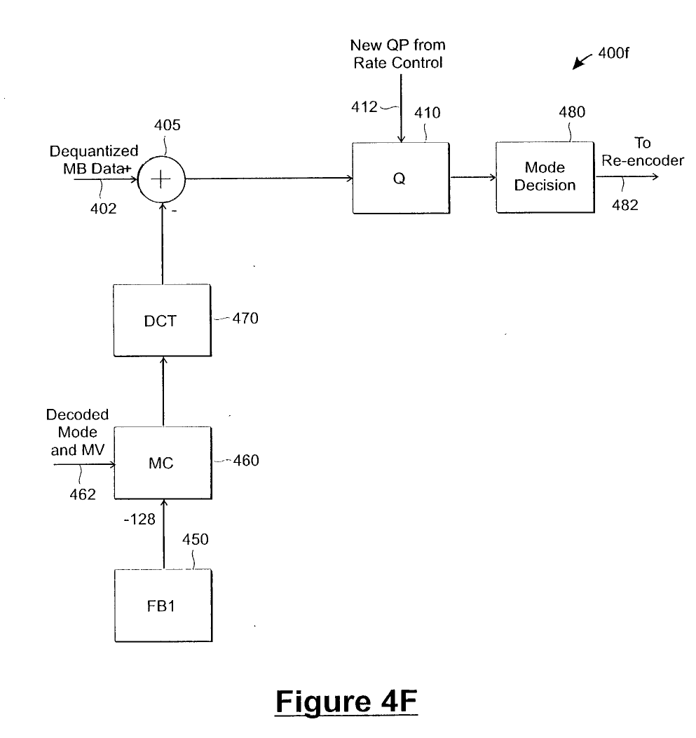

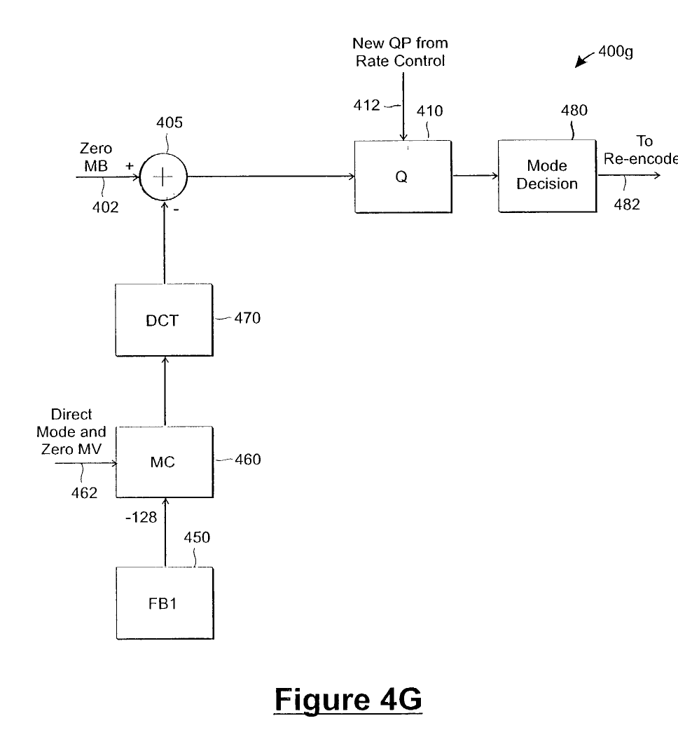

FIGS. 4A-4G are block diagrams of the various transcoding techniques used in processing decoded and dequantized block data, and are discussed hereinbelow in conjunction with descriptions of the various VOP types/MB coding types.

Transcoding of MBs in I-VOPs

The MBs in I-VOPs are coded in either intra or intra_q mode, i.e., they are coded without reference to other VOPs, either previous or subsequent. FIG. 4A is a block diagram of a transcode block 400a configured for processing intralintra q coded MBs. Dequantized MB Data 402 (compare 322, FIG. 3) enters the transcode block 400a and is presented to a quantizer block 410. The quantizer block re-quantizes the dequantized MB data 402 according to new QP 412 from the rate control block (ref. 180, FIG. 1) and presents the resultant requantized MB data to a mode decision block 480, wherein an appropriate mode choice is made for re-encoding the requantized MB data. The requantized MB data and mode choice 482 are passed on to the re-encoder (see 160, FIG. 1). The technique by which the coding mode decision is made is described in greater detail hereinbelow. Dequantized MB data in intra/intra_q coding mode are quantized directly without motion compensation (MC). The requantized MB is also passed to a dequantizer block 420 (Q⁻¹) where the quantization process is undone to produce DCT coefficients. As will be readily appreciated by those of ordinary skill in the art, both the dequantized MB data 402 presented to the transcode block 400a and the DCT coefficients produced by the dequantization block 420 are frequency-domain representations of the video image data represented by the MB being transcoded. However, since quantization done by the quantization block 410 is performed according to (most probably) different QP than those used on the original MB data from which the dequantized MB data 402 was derived, there will be differences between the DCT coefficients emerging from the dequantization block 420 and the dequantized MB data 402 presented to the transcode block 400a. These differences are calculated in a differencing block 425, and are IDCT-processed (Inverse Discrete Cosine Transform) in an IDCT block 430 to produce an “error-image” representative of the quantizing errors in the final output video bitstream that result from these differences. This error-image representation of the quantization errors is stored into a frame buffer 440 (FB2). Since the quantization errors can be either positive or negative, but pixel data is unsigned, the error-image representation is offset by one half of the dynamic range of FB2. For example, assuming an 8 bit pixel, any entry in FB2 can range from 0 to 255. The image data would then be biased upward by +128 so that error image values from −128 to +127 correspond to FB2 entry values of 0 to 255. The contents of FB2 are stored for motion compensation (MC) in combination with MBs associated with other VOP-types/coding types.

Those of ordinary skill in the art will immediately recognize that there are many different possible ways of handling numerical conversions (where numbers of different types, e.g., signed and unsigned, are to be commingled), and that the biasing technique described above is merely a representative one of these techniques, and is not intended to be limiting.

It should be noted that none of the MBs in I-VOP can be skipped.

Transcoding of MBs in P-VOPs

The MBs in P-VOP can be coded in intra/intra_q, inter/inter_q/inter_{—}4MV, or skipped. The MBs of difference types (inter, inter_q, inter_{—}4MV) are transcoded differently. Intra/intra_q coded MBs of P-VOPs are transcoded as shown and described hereinabove with respect to FIG. 4A. Inter, inter_q, and inter_{—}4MV coded MBs are transcoded as shown in FIG. 4B. Skipped MBs are handled as shown in FIG. 4C.

FIG. 4B is a block diagram of a transcode block 400b, adapted to transcoding of MB data that was originally inter, inter_q, or inter_{—}4MV coded, as indicated by the VOP and MB headers. These coding modes employ motion compensation. Before transcoding P-VOPs, the contents of frame buffer FB2 440 are transferred to frame buffer FB1 450. The contents of FB1 are presented to a motion compensation block 460. The bias applied to the error image data prior to its storage in FB2 440 is reversed upon retrieval from FB1 450. The motion compensation block 460 (MC) also receives code mode and motion vector information (from the MB header partial decode, ref. FIG. 3) and operates as specified in the MPEG-4 specification to generate a motion compensation “image” that is then DCT processed in a DCT block 470 to produce motion compensation DCT coefficients. These motion compensation DCT coefficients are then combined with the incoming dequantized MB data in a combining block 405 to produce motion compensated MB data. The resultant combination, in effect, applies motion compensation only to the transcoded MB errors (differences between the original MB data and the transcoded MB data 482 as a result of requantization using different QP).

The motion compensated MB data is presented to the quantizer block 410. In similar fashion to that shown and described hereinabove with respect to FIG. 4A, the quantizer block re-quantizes the motion compensated MB data according to new QP 412 from the rate control block (ref. 180, FIG. 1) and presents the resultant requantized MB data to a mode decision block 480, wherein an appropriate mode choice is made for re-encoding the requantized MB data. The requantized MB data and mode choice 485 are passed on to the re-encoder (see 160, FIG. 1). The technique by which the coding mode decision is made is described in greater detail hereinbelow. The requantized MB is also passed to the dequantizer block 420 (Q⁻¹ ) where the quantization process is undone to produce DCT coefficients. As before, since quantization done by the quantization block 410 is performed according to different QP than those used on the original MB data from which the dequantized MB data 402 was derived, differences between the DCT coefficients emerging from the dequantization block 420 and the motion compensated MB data are calculated in a differencing block 425, and are IDCT-processed (Inverse Discrete Cosine Transform) in the IDCT block 430 to produce an “error-image” representative of the quantizing errors in the final output video bitstream that result from those differences. This error-image representation of the quantization errors is stored into frame buffer FB2 440, as before. Since the quantization errors can be either positive or negative, but pixel data is unsigned, the error-image representation is offset by one half of the dynamic range of FB2.

FIG. 4C is a block diagram of a transcode block 400c, adapted to MBs originally coded as “skipped”, as indicated by the VOP and MB headers. In this case, the MB and MB data are treated as if the coding mode is “inter”, and as if all coefficients (MB data) and all motion compensation vectors (MV) are zero. This is readily accomplished by forcing all of the dequantized MB data 402 and all motion vectors 462 (MV) to zero and transcoding as shown and described hereinabove with respect to FIG. 4B. Due to residual error information from previous frames, it is possible that the motion compensated MB data produced by the combiner block 405 will include nonzero elements, indicating image information to be encoded. Accordingly, it is possible that a skipped MB may produce a non-skipped MB after transcoding. This is because the new QP 412 assigned by rate control block (ref 180, FIG. 1) can change form MB to MB. An originally non-skipped MB may have no nonzero DCT coefficients after requantization. On the other hand, an originally skipped MB may have some nonzero DCT coefficients after MC and requantization.

Transcoding of MBs in S-VOPs

S-VOPs or “Sprite-VOPs” are similar to P-VOPs but permit two additional MB coding modes: inter_gmc and inter_gmc_q. S-VOP MBs originally coded in intra, intraq_q, inter, inter_q, and inter_{—}4MV are processed as described hereinabove for similarly encoded P-VOP MBs. S-VOP MBs originally coded inter_gmc, inter_gmc_q and skipped are processed as shown in FIG. 4D.

FIG. 4D is a block diagram of a transcode block 400d, adapted to transcoding of MB data that was originally inter_gmc, inter_gmc_q, as indicated by the VOP and MB headers. These coding modes employ GMC (Global Motion Compensation). As with P-VOPs, before transcoding S-VOP's, the contents of frame buffer FB2 440 are transferred to frame buffer FB1 450. The contents of FBI are presented to the motion compensation block 460, configured for GMC. The bias applied to the error image data prior to its storage in FB2 440 is reversed upon retrieval from FB1 450. The motion compensation block 460 (MC) also receives GMC parameter information 462 (from the MB header partial decode, ref. FIG. 3) and operates as specified in the MPEG-4 specification to generate a GMC “image” that is then DCT processed in a DCT block 470 to produce motion compensation DCT coefficients. These motion compensation DCT coefficients are then combined with the incoming dequantized MB data in a combining block 405 to produce GMC MB data. The resultant combination, in effect, applies GMC only to the transcoded MB errors (differences between the original MB data and the transcoded MB data 482 as a result of requantization using different QP).

The GMC MB data is presented to the quantizer block 410. In similar fashion to that shown and described hereinabove with respect to FIGS. 4A-4C, the quantizer block re-quantizes the GMC MB data according to new QP 412 from the rate control block (ref. 180, FIG. 1) and presents the resultant requantized MB data to a mode decision block 480, wherein an appropriate mode choice is made for re-encoding the requantized MB data. The requantized MB data and mode choice 485 (we cannot find 485 in FIG. 1) are passed on to the re-encoder (see 160, FIG. 1). The technique by which the coding mode decision is made is described in greater detail hereinbelow. The requantized MB is also passed to the dequantizer block 420 (Q⁻¹) where the quantization process is undone to produce DCT coefficients. As before, since quantization done by the quantization block 410 is performed according to different QP than those used on the original MB data from which the dequantized MB data 402 was derived, differences between the DCT coefficients emerging from the dequantization block 420 and the GMC MB data are calculated in a differencing block 425, and are IDCT-processed (Inverse Discrete Cosine Transform) in the IDCT block 430 to produce an “error-image” representative of the quantizing errors in the final output video bitstream that result from those differences. This error-image representation of the quantization errors is stored into frame buffer FB2 440, as before. Since the quantization errors can be either positive or negative, but pixel data is unsigned, the error-image representation is offset by one half of the dynamic range of FB2.

FIG. 4E is a block diagram of a transcode block 400e, adapted to MBs originally coded as “skipped”, as indicated by the VOP and MB headers. In this case, the MB and MB data are treated as if the coding mode is “inter_gmc”, and as if all coefficients (MB data) are zero. This is readily accomplished by forcing the mode selection, setting GMC motion compensation (462), and forcing all of the dequantized MB data 402 to zero, then transcoding as shown and described hereinabove with respect to FIG. 4D. Due to residual error information from previous frames, it is possible that the GMC MB data produced by the combiner block 405 will include nonzero elements, indicating image information to be encoded. Accordingly, it is possible that a skipped MB may produce a non-skipped MB after transcoding. This is because the new QP 412 assigned by rate control block (ref 180, FIG. 1) can change form MB to MB. An originally non-skipped MB may have no nonzero DCT coefficients after requantization. On the other hand, an originally skipped MB may have some nonzero DCT coefficients after GMC and requantization.

Transcoding of MBs in B-VOPs

B-VOPs, or “Bidirectionally predictive-coded VOPs” do not encode new image data, but rather interpolate between past I-VOPs or P-VOPs, future I-VOPs or P-VOPs, or both. (“Future” VOP information is acquired by processing B-VOPs out of frame-sequential order, i.e., after the “future” VOPs from which they derive image information). Four coding modes are defined for B-VOPs: direct, interpolate, backward and forward. Transcoding of B-VOP MBs in these modes is shown in FIG. 4F. Transcoding of B-VOP MBs originally coded as “skipped” is shown in FIG. 4G.

FIG. 4F is a block diagram of a transcode block 400f, adapted to transcoding of MB data that was originally direct, forward, backward or interpolate coded as indicated by the VOP and MB headers. These coding modes employ Motion Compensation. Prior to transcoding, error-image information from previous (and/or future) VOPs is disposed in frame buffer FB1 450. The contents of FB1 are presented to the motion compensation block 460. Any bias applied to the error image data prior to its storage in the frame buffer FB1 450 is reversed upon retrieval from frame buffer FB1 450. The motion compensation block 460 (MC) receives motion vectors (MV) and coding mode information 462 (from the MB header partial decode, ref. FIG. 3) and operates as specified in the MPEG-4 specification to generate a motion compensated MC “image” that is then DCT processed in a DCT block 470 to produce MC DCT coefficients. These MC DCT coefficients are then combined with the incoming dequantized MB data 402 in a combining block 405 to produce MC MB data. The resultant combination, in effect, applies motion compensation only to the transcoded MB errors (differences between the original MB data and the transcoded MB data 482 as a result of requantization using different QP) from other VOPs—previous, future, or both, depending upon the coding mode.

The MC MB data is presented to the quantizer block 410. The quantizer block re-quantizes the MC MB data according to new QP 412 from the rate control block (ref. 180, FIG. 1) and presents the resultant requantized MB data to a mode decision block 480, wherein an appropriate mode choice is made for re-encoding the requantized MB data. The requantized MB data and mode choice 485 are passed on to the re-encoder (see 160, FIG. 1). The technique by which the coding mode decision is made is described in greater detail hereinbelow. Since B-VOPs are never used in further motion compensation, quantization errors and their resultant error image are not calculated and stored for B-VOPs.

FIG. 4G is a block diagram of a transcode block 400g, adapted to B-VOP MBs that were originally coded as “skipped”, as indicated by the VOP and MB headers. In this case, the MB and MB data are treated as if the coding mode is “direct”, and as if all coefficients (MB data) and motion vectors are zero. This is readily accomplished by forcing the mode selection and motion vectors 462 to “forward” and zero, respectively, and forcing all of the dequantized MB data 402 to zero, then transcoding as shown and described hereinabove with respect to FIG. 4F. Due to residual error information from previous frames, it is possible that the MC MB data produced by the combiner block 405 will include nonzero elements, indicating image information to be encoded. Accordingly, it is possible that a skipped MB may produce a non-skipped MB after transcoding. This is because the new QP 412 assigned by rate control block (ref 180, FIG. 1) can change form MB to MB. An originally non-skipped MB may have no nonzero DCT coefficients after requantization. On the other hand, an originally skipped MB may have some nonzero DCT coefficients after GMC and requantization.

It will be evident to those of ordinary skill in the art that there is considerable commonality between the block diagrams shown and described hereinabove with respect to FIGS. 4A-4G. Although described hereinabove as if separate entities for transcoding the various coding modes, a single transcode block can readily be provided to accommodate all of the transcode operations for all of the coding modes described hereinabove. For example, a transcode block such as that shown in FIG. 4B, wherein the MC block can also accommodate GMC, is capable of accomplishing all of the aforementioned transcode operations. This is highly efficient, and is the preferred mode of implementation. The transcode block 150 of FIG. 1 refers to the aggregate transcode functions of the complete transcoder 100, whether implemented as a group of separate, specialized transcode blocks, or as a single, universal transcode block.

Mode Decision

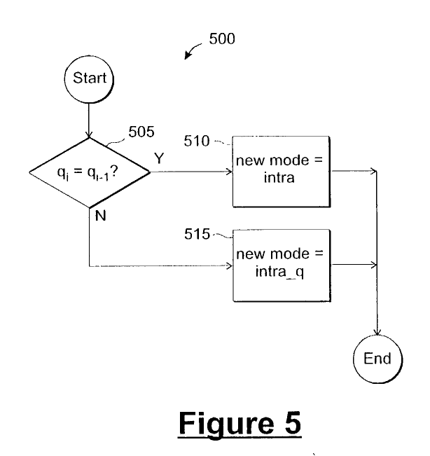

In the foregoing discussion with respect to transcoding, each transcode scenario includes a step of re-encoding the new MB data according to an appropriate choice of coding mode. The methods for determining coding modes are shown in FIGS. 5, 6, 7a, 7b, 8a and 8b. Throughout the following discussion with respect to these Figures, reference numbers from the figures corresponding to actions and decisions in the description are enclosed in parentheses.

Coding Mode Determination for I-VOPs

FIG. 5 is a flowchart 500 showing the method by which the re-coding mode is determined for I-VOP MBs. In a decision step 505, it is determined whether new QP (qₗ) are the same as previous QP (q_{l—1}). If they are the same, the new coding mode (re-coding mode) is set to intra in a step 510. If not, the new coding mode is set to intra_q in a step 515.

Coding Mode Determination for P-VOPs

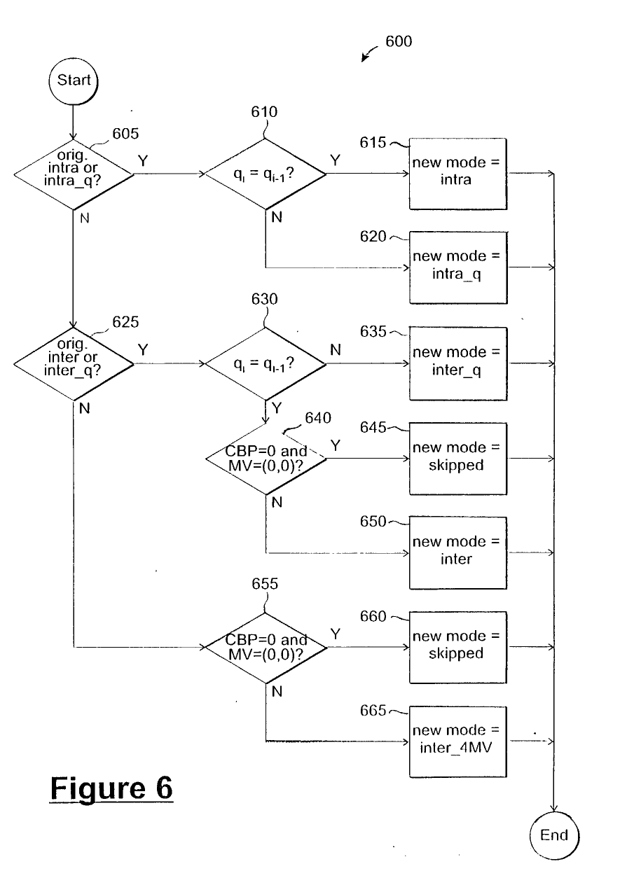

FIG. 6 is a flowchart 600 showing the method by which the re-coding mode is determined for P-VOP MBs. In a first decision step 605, if the original P-VOP MB coding mode was either intra or intra_q, then the mode determination process proceeds on to a decision step 610. If not, mode determination proceeds on to a decision step 625.

In the decision step 610, if the new QP (qᵢ) are the same as previous QP (qᵢ₋₁), the new coding mode is set to intra in a step 615. If not, the new coding mode is set to intra_q in a step 620.

In the decision step 625, if the original P-VOP MB coding mode was either inter or inter_q, then mode determination proceeds on to a decision step 630. If not, mode determination proceeds on to a decision step 655.

In the decision step 630, if the new QP (qᵢ) are not the same as previous QP (qᵢ₋₁), the new coding mode is set to inter_q 635. If they are the same, mode determination proceeds on to a decision step 640 where it is determined if the coded block pattern (CBP) is all zeroes and the motion vectors (MV) are zero. If they are, the new coding mode is set to “skipped” in a step 645. If not, the new coding mode is set to inter in a step 650.

In the decision step 655, since the original coding mode has been previously determined not to be inter, inter_q, intra or intra_q, then it is assumed to be inter_{—}4MV, the only other possibility. If the coded block pattern (CBP) is all zeroes and the motion vectors (MV) are zero, then the new coding mode is set to “skipped” in a step 660. If not, the new coding mode is set to inter_{—}4MV in a step 665.

Coding Mode Determination for S-VOPs

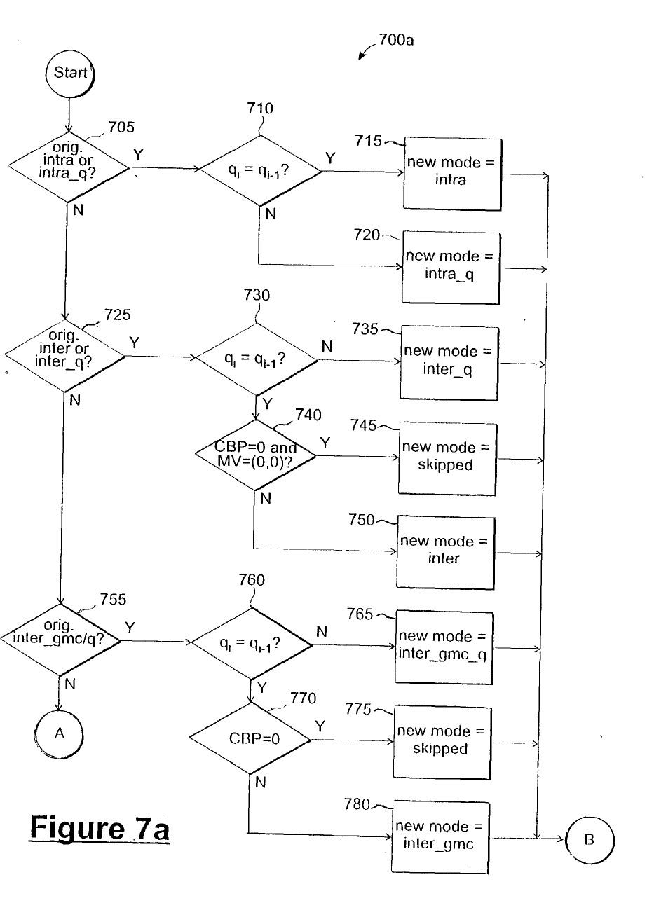

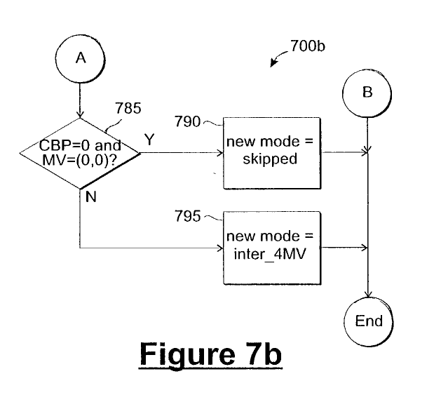

FIGS. 7a and 7b are flowchart portions 700a and 700b which, in combination, form a single flowchart showing the method by which the re-coding mode is determined for S-VOP MBs. Connectors “A” and “B” indicate the points of connection between the flowchart portions 700a and 700b. FIGS. 7a and 7b are described in combination.

In a decision step 705, if the original S-VOP MB coding mode was either intra or intra_q, then the mode determination process proceeds on to a decision step 710. If not, mode determination proceeds on to a decision step 725.

In the decision step 710, if the new QP (qᵢ) are the same as previous QP (qᵢ₋₁), the new coding mode is set to intra in a step 715. If not, the new coding mode is set to intra_q in a step 720.

In the decision step 725, if the original S-VOP MB coding mode was either inter or inter_q, then mode determination proceeds on to a decision step 730. If not, mode determination proceeds on to a decision step 755.

In the decision step 730, if the new QP (qᵢ) are not the same as previous QP (qᵢ₋₁), the new coding mode is set to inter_q in a step 735. If they are the same, mode determination proceeds on to a decision step 740 where it is determined if the coded block pattern (CBP) is all zeroes and the motion vectors (MV) are zero. If they are, the new coding mode is set to “skipped” in a step 745. If not, the new coding mode is set to inter in a step 750.

In the decision step 755, if the original S-VOP MB coding mode was either inter_gmc or inter_gmc_q, then mode determination proceeds on to a decision step 760. If not, mode determination proceeds on to a decision step 785 (via connector “A”).

In the decision step 760, if the new QP (qᵢ) are not the same as previous QP (qᵢ₋₁), the new coding mode is set to inter_gmc_q in a step 765. If they are the same, mode determination proceeds on to a decision step 770 where it is determined if the coded block pattern (CBP) is all zeroes. If so, the new coding mode is set to “skipped” in a step 775. If not, the new coding mode is set to inter in a step 780.

In the decision step 785, since the original coding mode has been previously determined not to be inter, inter_q, inter_gmc, inter gmc_q, intra or intra_q, then it is assumed to be inter_{—}4MV, the only other possibility. If the coded block pattern (CBP) is all zeroes and the motion vectors (MV) are zero, then the new coding mode is set to “skipped” in a step 790. If not, the new coding mode is set to inter_{—}4MV in a step 795.

Coding Mode Determination for B-VOPs

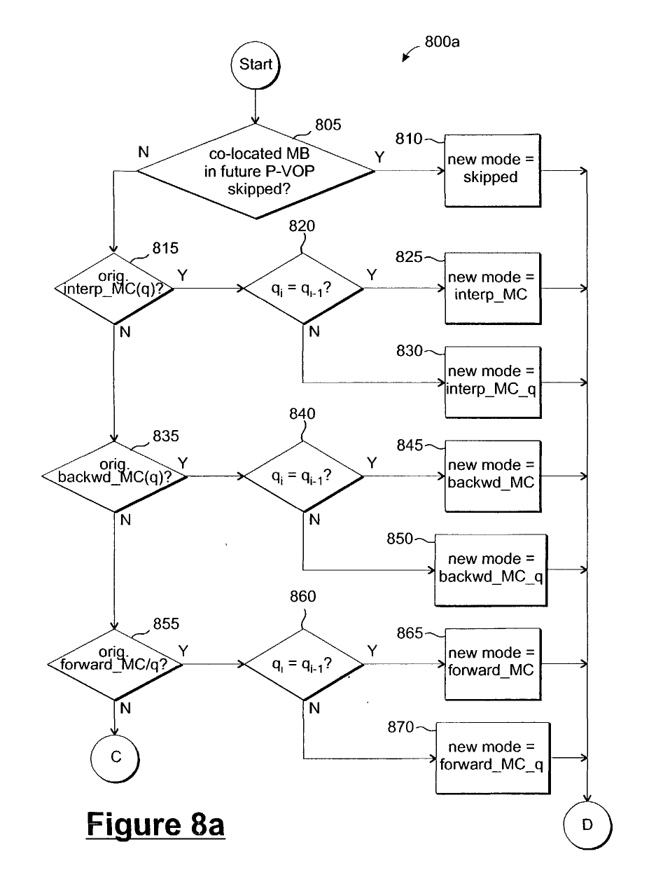

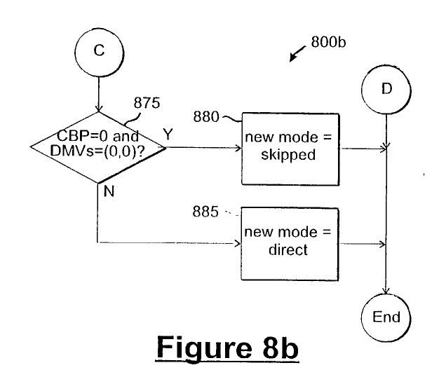

FIGS. 8a and 8b are flowchart portions 800a and 800b which, in combination, form a single flowchart showing the method by which the re-coding mode is determined for B-VOP MBs. Connectors “C” and “D” indicate the points of connection between the flowchart portions 800a and 800b. FIGS. 8a and 8b are described in combination.

In a first decision step 805, if a co-located MB in a previous P-VOP (MV corresponding to the same position in the encoded video image) was coded as skipped, then the new coding mode is set to skipped in a step 810. If not, mode determination proceeds to a decision step 815, where it is determined if the original B-VOP MB coding mode was “interpolated” (interp_MC or interp_MC_q). If so, the mode determination process proceeds to a decision step 820. If not, mode determination proceeds on to a decision step 835.

In the decision step 820, if the new QP (qᵢ) are the same as previous QP (qᵢ₋₁), the new coding mode is set to interp_MC in a step 825. If not, the new coding mode is set to interp_MC_q in a step 830.

In a decision step 835, if the original B-VOP MB coding mode was “backward” (either backwd or backwd_q), then mode determination proceeds on to a decision step 840. If not, mode determination proceeds on to a decision step 855.

In the decision step 840, if the new QP (qᵢ) are the same as previous QP (qᵢ₋₁), the new coding mode is set to backward_MC in a step 845. If not, the new coding mode is set to backward_MC_q in a step 850.

In the decision step 855, if the original B-VOP MB coding mode was “forward” (either forward_MC or forward_MC_q), then mode determination proceeds on to a decision step 860. If not, mode determination proceeds on to a decision step 875 (via connector “C”).

In the decision step 860, if the new QP (qᵢ) are the same as previous QP (qᵢ₋₁), the new coding mode is set to forward_MC in a step 865. If not, the new coding mode is set to forward_MC_q in a step 870.

In the decision step 875, since the original coding mode has been previously determined not to be interp_MC, interp_MC_q, backwd_MC, backwd_MC_q, forward or forward_MC_q, then it is assumed to be direct, the only other possibility. If the coded block pattern (CBP) is all zeroes and the motion vectors (MV) are zero, then the new coding mode is set to “skipped” in a step 880. If not, the new coding mode is set to direct in a step 885.

Re-encoding

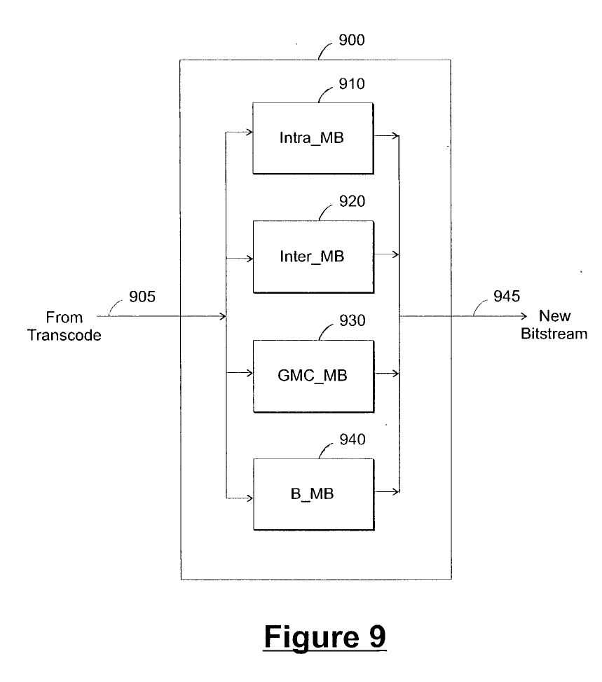

FIG. 9 is a block diagram of a re-encoding block 900 (compare 160, FIG. 1), wherein four encoding modules (910, 920, 930, 940) are employed to process a variety of re-encoding tasks. The re-encoding block 900 received data 905 from the transcode block (see 150, FIG. 1 and FIGS. 4A-4G) consisting of requantized MB data for re-encoding and a re-encoding mode. The re-encoding mode determines which of the re-encoding modules will be employed to re-encode the requantized MB data. The re-encoded MB data is used to provide a new bitstream 945.

An Intra_MB re-encoding module 910 is used to re-encode in intra and intra q modes for MBs of I-VOPs, P-VOPs, or S-VOPs. An Inter_MB re-encoding module 920 is used to re-encode in inter, inter_q, and inter_{—}4MV modes for MBs of P-VOPs or S-VOPs. A GMC_MB re-encoding module 930 is used to re-encode in inter_gmc and inter_gmc_q modes for MBs of S-VOPs. A B_MB re-encoding module handles all of the B-VOP MB encoding modes (interp_MC, interp_MC_q, forward, forward_MC_q, backwd, backwd_MC_q, and direct).

In the new bitstream 945, the structure of MB layer in various VOPs will remain the same, but the content of each field is likely different. Specifically:

VOP Header Generation

I-VOP Headers

All of the fields in the MB layer may be coded differently from the old bit stream. This is because, in part, the rate control engine may assign a new QP for any MB. If it does, this results in a different CBP for the MB. Although the AC coefficients are requantized by the new QP, all the DC coefficients in intra mode are always quantized by eight. Therefore, the re-quantized DC coefficients are equal to the originally encoded DC coefficients. The quantized DC coefficients in intra mode are spatial-predictive coded. The prediction directions are determined based upon the differences between the quantized DC coefficients of the current block and neighboring blocks (i.e., macroblocks). Since the quantized DC coefficients are unchanged, the prediction directions for DC coefficients will not be changed. The AC prediction directions follow the DC prediction directions. However, since the new QP assigned for a MB may be different from the originally coded QP, the scaled AC prediction may be different. This may result in a different setting of the AC prediction flag (ACpred_flag), which indicates whether AC prediction is enabled or disabled. The new QP is differentially encoded. Further, since the change in QP from MB to MB determined by the rate control block (ref. 180, FIG. 1), the DQUANT parameter may be changed as well.

P-VOP Headers:

All of the fields in the MB layer, except the MVDs, may be different from the old bitstream. Intra and intra_q coded MBs are re-encoded as for I-VOPs. Inter and inter_q MBs may be coded or not, as required by the characteristics of the new bit stream. The MVs are differentially encoded. PMVs for a MB for are the medians of neighboring MVs. Since MVs are unchanged, PMVs are unchanged as well. The same MVDs are therefore re-encoded into the new bit stream.

S-VOP Headers

All of the fields in the MB layer, except the MVDs, may be different from the old bit stream (FIG. 6). Intra, intra_q, inter and inter_q MBs are re-encoded as in I- and P-VOP. For GMC MBs, the parameters are unchanged.

B-VOP Headers

All of the fields in the MB layer, except the MVDs, may be different from the old bitstream. MVs are calculated from PMV and DMV in MPEG-4. PMV in B-VOP coding mode can be altered by the transcoding process. The Mv resynchronization process modifies DMV values such that the transcoded bitstream can produce an MV identical to the original MV in the input bitstream. The decoder stores PMVs for backward and forward directions. PMVs for direct mode are always zero and are treated independently from backward and forward PMVs. PMV is replaced by either zero at the beginning of each MB row or value of MB (forward, backward, or both) when MB is MC coded (forward, backward, or both, respectively). PMVs are unchanged when MB is coded as skipped. Therefore, PMVs generated by transcoded bitstream can differ from those in the input bitstream if an MB changes from skipped mode to a MC coded mode or vice versa. Preferably, the PMVs at the decoding and re-encoding processes are two separate variables stored independently. The re-encoding process resets the PMVs at the beginning of each row and updates PMVs whenever MB is MC coded. Moreover, the re-encoding process finds a residual of MV, PMV and determines its VLC (variable length code) for inclusion in the transcoded bitstream. Whenever MB is not coded as skipped, PMV is updated and a residual of MV and its corresponding VLC are recalculated.

Rate Control

Referring once again to FIG. 1, the rate control block 180 determines new quantization parameters (QP) for transcoding based upon a target bit rate 104. The rate control block assigns each VOP a target number of bits based upon the VOP type, the complexity of the VOP type, the number of VOPs within a time window, the number of bits allocated to the time window, scene change, etc. Since MPEG-4 limits the change in QP from MB to MB to +/−2, an appropriate initial QP per VOP is calculated to meet the target rate. This is accomplished according to the following equation:

$${q}_{new} = \frac{{R}_{old}}{{T}_{new}} \cdot {q}_{old}$$

where:

R_{old} is the number of bits per VOP

T_{new} is the target number of bits

q_{old} is the old QP and

q_{new} is the new QP.

The QP is adjusted on a MB-by-MB basis to meet the target number of bits per VOP. The output bitstream (new bitstream, 162) is examined to see if the target VOP bit allocation was met. If too many bits have been used, the QP is increased. If too few bits have been used, the QP is decreased.

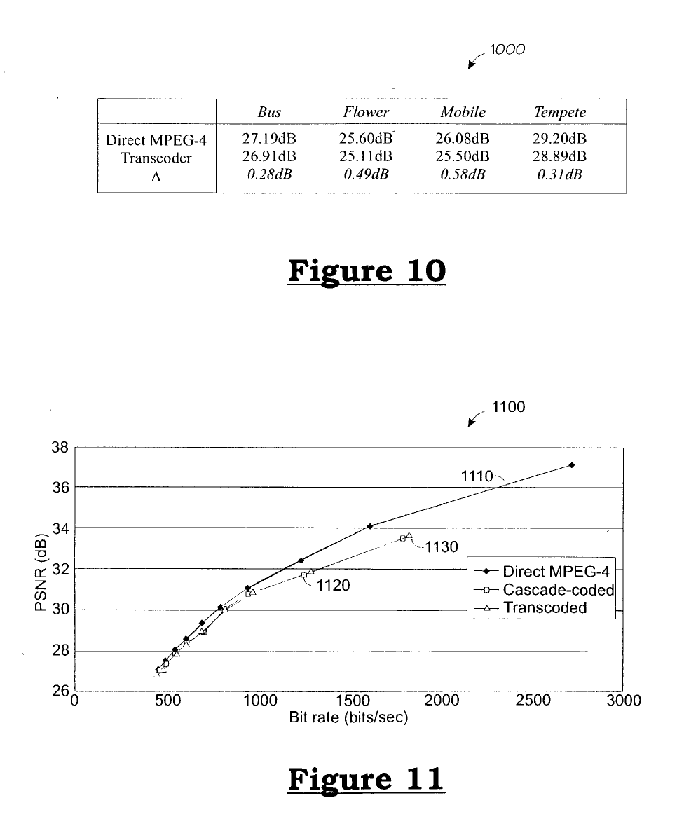

In evaluating the performance of the MPEG-4 transcoder, simulations are carried out for a number of test video sequences. All the sequences are in CIF format: 352×288 and 4:2:0. The test sequences are first encoded using MPEG-4 encoder at 1 Mbits/sec. The compressed bit streams are then transcoded into the new bit streams at 500 Kbits/sec. For comparison purposes, the same sequences are also encoded using MPEG-4 encoded directly at 500 kbits/sec. The results are presented in the table of FIG. 10 which illustrates PSNR for sequences at CIF resolution using direct MPEG-4 and transcoder at 500 Kbits/sec. As seen, the difference in PSNR by direct MPEG-4 and transcoder is about a half dB −0.28 dB for bus, 0.49 dB for Flower, 0.58 dB for Mobile and 0.31 for Tempete. The quality loss is due to the fact that the transcoder quantizes the video signals twice, and therefore introduces additional quantization noise.

As an example, FIG. 11 shows the performance of the transcoder for bus sequence at VBR, or with fixed QP, in terms of PSNR with respect to the average bit rate. The diamond-line is the direct MPEG-4 at fixed QP=4,6,8,10,12,14,16,18,20 and 22. The compressed bit stream with QP=4 is then transcoded at QP=6,8,10,12,14,16,18,20,and 22. At lower rates, the transcoded performance is very close to direct MPEG-4, while at higher rates, there is about 1 dB difference. The performance of cascaded coding and transcoder are almost identical. However, the implementation of the transcoder is much simpler than the cascaded coding.

Although the invention has been described in connection with various specific embodiments, those skilled in the art will appreciate that numerous adaptations and modifications may be made thereto without departing from the spirit and scope of the invention as set forth in the claims.

What is claimed is:

1. A method for transcoding an input compressed video bitstream to an output compressed video bitstream at a different bit rate, comprising:
receiving an input compressed video bitstream at a first bit rate;
specifying a new target bit rate for an output compressed video bitstream;
partially decoding the input bitstream to produce dequantized data;
requantizing the dequantized data using a different quantization level (QP) to produce requantized data; and
re-encoding the requantized data to produce the output compressed video bitstream.

2. The method of claim 1, further comprising:
determining an appropriate initial quantization level (QP) for requantizing;
monitoring the bit rate of the output compressed video bitstream; and
adjusting the quantization level to make the bit rate of the output compressed video bitstream closely match the target bit rate.

3. The method of claim 1, further comprising:
copying invariant header data directly to the output compressed video bitstream.

4. The method of claim 1, further comprising:
determining requantization errors by dequantizing the requantized data and subtracting from the dequantized data;
IDCT processing the quantization errors to produce an equivalent error image;
applying motion compensation to the error image according to motion compensation parameters from the input compressed video bitstream; and
DCT processing the motion compensated error image and applying the DCT-processed error image to the dequantized data as motion compensated corrections for errors due to requantization.

5. Apparatus for transcoding an input compressed video bitstream to an output compressed video bitstream at a different bit rate, comprising:
means for receiving an input compressed video bitstream at a first bit rate;
means for specifying a new target bit rate for an output compressed video bitstream;
means for partially decoding the input bitstream to produce dequantized data;
means for requantizing the dequantized data using a different quantization level (QP) to produce requantized data; and
means for re-encoding the requantized data to produce the output compressed video bitstream.

6. The apparatus of claim 5, further comprising:
means for determining an appropriate initial quantization level (QP) for requantizing;
means for monitoring the bit rate of the output compressed video bitstream; and
means for adjusting the quantization level to make the bit rate of the output compressed video bitstream closely match the target bit rate.

7. The apparatus of claim 5, further comprising:
means for copying invariant header data directly to the output compressed video bitstream.

8. The apparatus of claim 5, further comprising:
means for determining requantization errors by dequantizing the requantized data and subtracting from the dequantized data;
means for IDCT processing the quantization errors to produce an equivalent error image;
means for applying motion compensation to the error image according to motion compensation parameters from the input compressed video bitstream; and
means for DCT processing the motion compensated error image and applying the DCT-processed error image to the dequantized data as motion compensated corrections for errors due to requantization.

9. A method for transcoding an input compressed video bitstream to an output compressed video bitstream at a different bit rate, comprising:
receiving an input bitstream;
extracting a video object layer header from the input bitstream;
dequantizing macroblock data from the input bitstream;
requantizing the dequantized macroblock data; and
inserting the extracted video object layer header into the output bitstream, along with the requantized macroblock data.

10. The method of claim 9, further comprising:
extracting a group of video object plane header from the input bitstream; and
inserting the extracted group of video object plane header into the output bitstream.

11. The method of claim 9, further comprising:
extracting a video object plane header from the input bitstream; and
inserting the extracted video object plane header into the output bitstream.

12. The method of claim 9, further comprising:
determining an appropriate initial quantization level (QP) for requantizing;
monitoring the bit rate of the output compressed video bitstream; and
adjusting the quantization level to make the bit rate of the output compressed video bitstream closely match a target bit rate.

13. The method of claim 9, further comprising:
copying invariant header data directly from the input bitstream to the output bitstream.

14. The method of claim 9, further comprising:
determining requantization errors by dequantizing the requantized data and subtracting from the dequantized data;
IDCT processing the quantization errors to produce an equivalent error image;
applying motion compensation to the error image according to motion compensation parameters from the input compressed video bitstream; and
DCT processing the motion compensated error image and applying the DCT-processed error image to the dequantized data as motion compensated corrections for errors due to requantization.

15. The method of claim 9, further comprising:
representing the requantization errors as 8 bit signed numbers;
adding an offset of one-half of the span of the requantization errors thereto prior to storing the requantization errors in an 8 bit unsigned storage buffer; and
subtracting the offset from the requantization errors after retrieval from the 8 bit unsigned storage buffer.

16. The method of claim 9, further comprising:
for MBs coded as “skipped”, presenting an all-zero MB to the transcoder.

17. The method of claim 16, further comprising:
for predictive VOP modes with MBs coded as “skipped”, presenting all-zero MV values to the transcoder.

18. The method of claim 9, further comprising:
determining if, after transcoding and motion compensation, the coded block pattern is all zeroes, and if so, selecting a coding mode of “skipped”

19. The method of claim 9, further comprising:
for predictive VOP modes, determining if, after transcoding and motion compensation, the coded block pattern is all zeroes and if the MV values are all zeroes, and if so, selecting a coding mode of “skipped”

20. The method of claim 9, further comprising:
for P-VOPs, S-VOPs and B-VOPs where the original coding mode was “skipped”, determining if, after transcoding:
the coded block pattern is all zeroes; and
the MVs are all zeroes; and
selecting a coding mode of “skipped” only if both conditions are true.

21. The method of claim 9, further comprising:
for P-VOPs where:
the original coding mode was “skipped”;
the input MB is all zeroes;
the mode is “forward”; and
the MVs are all zeroes;
determining if, after transcoding:
the coded block pattern is all zeroes; and
the MVs are all zeroes; and
selecting a coding mode of “skipped” only if both conditions are true.

22. The method of claim 9, further comprising:
for S-VOPs where:
the input MB is all zeroes;
the GMC setting is zero;
determining if, after transcoding:
the coded block pattern is all zeroes; and
the motion compensation is all zeroes; and
selecting a coding mode of “skipped” only if both conditions are true.

23. The method of claim 9, further comprising:
for B-VOPs where:
the input MB is all zeroes;
the mode is “direct”; and
the MVs are all zeroes;
determining if, after transcoding:
the coded block pattern is all zeroes;
the coding mode is “direct”; and
the MVs are all zeroes;
selecting a coding mode of “skipped” only if all three conditions are true.
